(19) United States
(12) Patent Application Publication
(10) Pub. No.: US 2018/0355592 A1
(43) Pub. Date: Dec. 13, 2018

(54) FLUID METERING AND DISPENSING APPARATUS

(71) Applicant: Evan MANDEL, Plainview, NY (US)

(72) Inventor: Evan MANDEL, Plainview, NY (US)

(21) Appl. No.: 15/621,015

(22) Filed: Jun. 13, 2017

(51) Int. Cl. E03C 1/05; G05D 7/06

(52) U.S. Cl. CPC E03C 1/055; G01F 1/075; G05D 7/0635

(57) ABSTRACT

A fluid metering and dispensing apparatus, for use with a fluid source, the fluid source having a fluid outlet. The apparatus comprises: an interface for receiving an input establishing an amount of fluid to be dispensed, and for outputting a signal indicative of the established amount of fluid in response to the input. A meter measures the amount of fluid exiting the fluid outlet, and generates an output signal indicative of the measured amount of fluid. A comparator receives the signals from the interface and the meter, and compares the measured amount of fluid exiting the fluid outlet with the desired amount of fluid established by the input to the interface. A shut-off receives an output from the comparator and shuts off a flow of fluid through the fluid outlet once the measured amount of fluid exiting the fluid outlet reaches the established amount of fluid to be dispensed.

### BACKGROUND OF THE INVENTION

### 1. Field of the Invention

The invention is directed to an apparatus for accurately metering and dispensing fluids from a source, such as water from a faucet.

### 2. Description of the Related Art

It is often necessary for individuals to measure and dispense fluids accurately. For example, chefs, whether amateur or professional, often must measure precise amounts of water for a recipe. Currently, the common practice is for the chef to “eyeball” a liquid level in a clear measuring cup, adding water to or subtracting water from the measuring cup as needed to ensure that the amount of water in the cup is at the desired level.

This presents some challenges, particularly for the amateur chef. Too much water and the dish is runny, too little and it is dry. Neither outcome is optimal, so accurate measurement is important.

Measuring the liquid level precisely can be daunting to some. Liquid in a measuring cup does not have a flat upper surface. Rather, the upper surface is somewhat concave, with the edges being higher than the middle, presenting a “meniscus” which can be confusing to the amateur chef who is unaccustomed to the measurement process. Furthermore, the level of the water is usually not at eye level for the chef, requiring the chef to bend down to get a better angle, or raise the cup up. Raising the cup up, however, means that the cup may not be level.

If the amount of water is too little, the chef must add some, and then re-measure. Then, as too often happens it is too much, requiring some to be poured out. This back and forth can be frustrating and tedious, often leading the chef to declare “good enough”, stopping the process even if the amount of water is not quite right. This makes the preparation of the dish more likely to be “off”, and may discourage amateur chefs from engaging in more challenging cooking efforts.

While professional chefs may not face the same difficulties in measuring, due to their experience and expertise, often, time constraints weigh heavily on professional chefs and so taking even a few extra precious seconds can be an imposition, for example in a busy commercial kitchen.

Furthermore, kitchens, whether at-home or commercial, are limited in space, and so a cumbersome apparatus for measuring and dispensing water would not be suitable, nor would an apparatus which is not connected to existing water sources.

It may also be useful if the temperature of the water being used could be accurately measured, for recipes calling for water of a specific temperature.

There is therefore a need to provide a mechanism for chefs, whether amateur or professional, which allows for the repeated, consistent and accurate dispensing of measured amounts of water, preferably by attachment to standard faucets in standard kitchens.

### SUMMARY OF THE INVENTION

It is an object of the invention to provide an improved water metering and dispensing apparatus for use in a kitchen.

It is preferable if the novel apparatus could also be compact and easy to use, even for an amateur chef with limited time.

It is further preferable if such an apparatus could be retro-fitted to an existing standard faucet, so that expensive remodeling of the kitchen would not be needed to utilize the apparatus.

Briefly stated, therefore, the invention is directed to a water measuring and dispensing apparatus for use with a faucet. The apparatus includes a fluid metering and dispensing apparatus, for use with a fluid source, the fluid source having a fluid outlet, the apparatus comprising: an interface for receiving an input from a user establishing an amount of fluid to be dispensed, and for outputting a signal in response to the user input, the signal being indicative of the established amount of fluid to be dispensed. The apparatus further comprises a meter for measuring the amount of fluid exiting the fluid outlet, the meter having an output indicative of the measured amount of fluid. Additionally, the apparatus includes a comparator for receiving the signal from the interface, and for comparing the measured amount of fluid exiting the fluid outlet with the amount of fluid established by the user input to the interface, the comparator having an output. Finally, the apparatus has a shut-off for receiving the output of the comparator and for shutting off a flow of fluid through the fluid outlet once the measured amount of fluid exiting the fluid outlet reaches the established amount of fluid to be dispensed.

In a preferred embodiment of the invention, the fluid to be dispensed is water, and the fluid outlet is a faucet, such as used in a kitchen sink.

The apparatus may be connected to the faucet with any suitable connection, such as by a threading located on the faucet being used to screw complementarily formed threads on the apparatus thereonto.

The interface may be of any desired type, including, but not limited to, a dial, a keypad, a touch screen input device, a cell phone, a computer, a tablet, a virtual assistant or other such device.

The interface may communicate with the comparator through any desired form of communication, whether wired or wireless, such as an RF connection or a Bluetooth connection.

The comparator may be part of a general purpose computing device, programmed to make the comparison, and store other, relevant information for use by the apparatus.

In a preferred embodiment of the invention, the apparatus may further include a flywheel which turns as the fluid passes through the apparatus. The flywheel may be used to re-charge a battery which is coupled to power one or more of the other components of the apparatus.

In a further preferred embodiment, the apparatus may be used as part of a new installation, and so would be pre-installed in a cabinet, or to a faucet or otherwise in the new installation, even, possibly, by integration into a refrigerator water filtration system. Alternately, the apparatus may be retro-fitted to a pre-existing installation, for example by screwing or snapping it onto the fluid output, such as a faucet, as mentioned previously.

It may also be preferred if the shut-off is a solenoid actuated valve which closes the fluid output in response to a signal from the comparator that the desired output has been reached.

Other objects and features of the present invention will become apparent from the following detailed description of the presently preferred embodiments, considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

FIG. 1 is a flow chart which illustrates, in schematic form, the operation of an apparatus in accordance with the invention;

FIG. 2 shows a stylized view of an application in which the inventive apparatus may be employed;

FIG. 3 is a cross-sectional view of the inventive apparatus; and

FIG. 4 is a schematic view of an input device used as part of the inventive apparatus.

### DETAILED DESCRIPTION OF THE PRESENTLY PREFERRED EMBODIMENTS

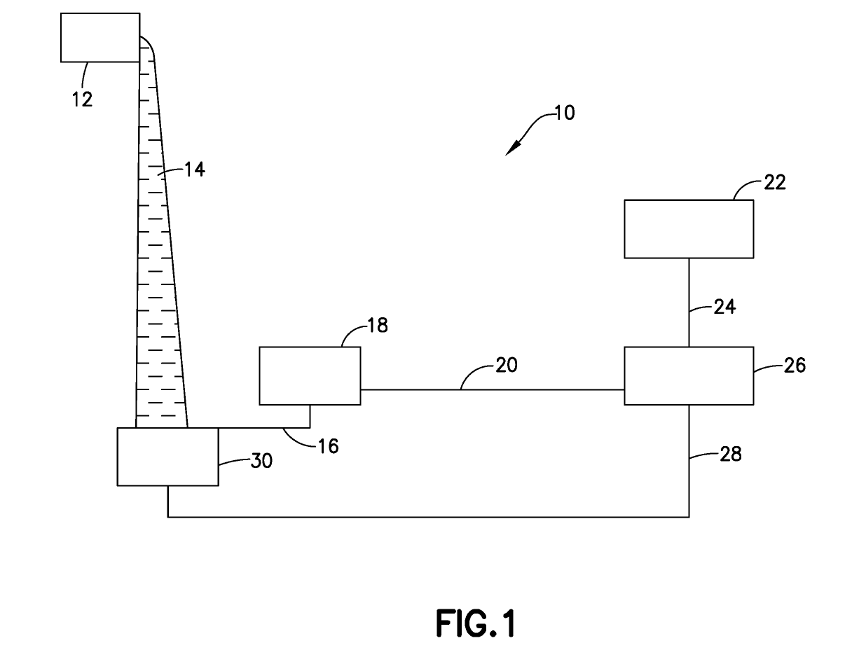

FIG. 1 shows a schematic block diagram, illustrating the operation of an inventive fluid metering and dispensing apparatus 10.

Apparatus 10 is intended to be used with a source 12 of a fluid, such as water. Source 12 generates a flow of fluid 14 from source 12 to a fluid output 16.

Apparatus 10 includes a meter 18, such as a flowmeter, for monitoring the flow 14 of fluid from source 12 to output 16. Meter 18 outputs a signal 20 indicative of the amount of fluid passing through fluid output 16.

Apparatus 10 further includes an interface 22 for accepting input from a user, establishing a desired amount of fluid to be dispensed at output 16. Interface 22 may be of any suitable type, such as, for example, a dial, a keypad, a touch screen input device, a cell phone, a computer, or a tablet. Interface 22 is capable of generating an output 24 indicative of the desired amount of fluid to be dispensed.

Signals 20 and 24 are received by a comparator 26, which compares the amount of fluid actually dispensed at output 16, as measured by meter 18, to the desired amount of fluid as input to interface 22, and, once the desired amount of fluid has been dispensed, sends a shut-off signal 28 to a fluid shut-off 30, such as a solenoid-actuated valve, to close output 16 via shut-off 30.

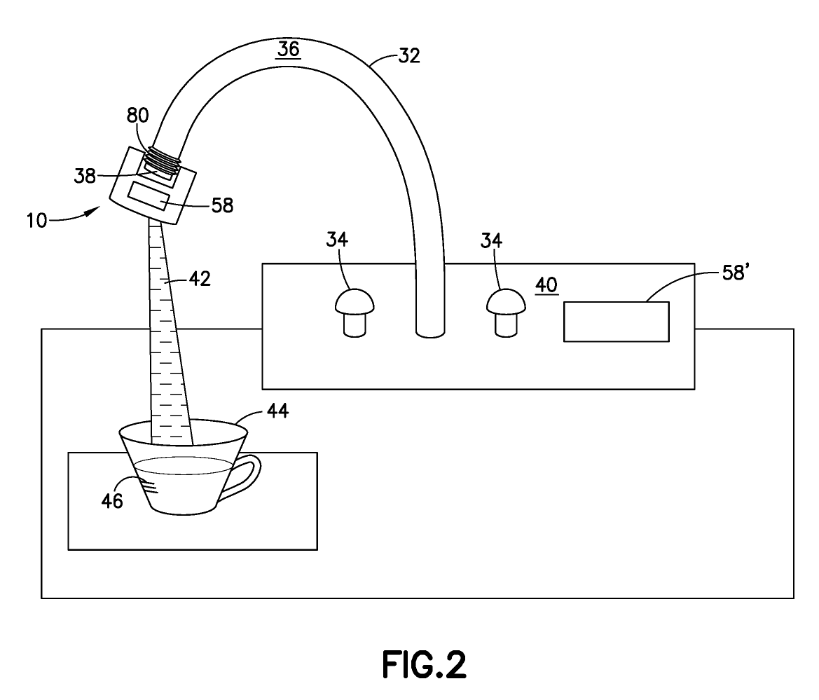

As illustrated in FIG. 2, a preferred application for apparatus 10 is in a kitchen, with a faucet 32 having handles 34, and a spout 36 having an outlet 38. Water flows through faucet 32, from a source (not shown) under a sink 40, through spout 36 to outlet 38. For our purposes, water (as illustrated by numeral 42) is dispensed to a measuring cup 44, bearing indicia 46.

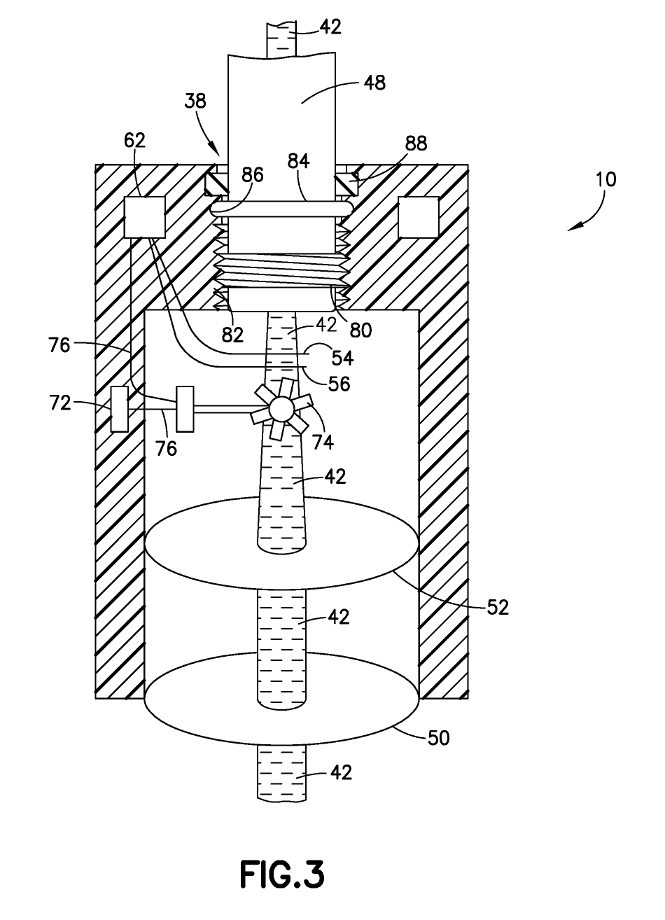

Conventionally, faucet 32 is actuated by handles 34 to initiate a flow of water 42 through spout 36 to outlet 38, and thereby to measuring cup 44. A user, such as a chef, would turn handles 34 to adjust the temperature and volume of flow of water 42, and turn handles 34 to stop the flow of water 42 when the desired level of water is in measuring cup 44 as shown by indicia 46. However, as discussed above, this can be inexact, leading to adding more water to, or pouring water from, measuring cup 44, to reach the desired amount of water for the recipe. The problem of measuring the water to be dispensed is addressed by the addition of inventive apparatus 10, shown in more detail in FIG. 3.

Apparatus 10 includes a fluid input 48 and a fluid output 50. Positioned intermediate input 48 and output 50 is a shut-off 52. Shut-off 52 may be of any convenient type, such as a constricting valve, a rotating closure and a movable flap. In the preferred embodiment, shut-off 52 is a solenoid-actuated valve, which acts to shut off the flow of water 42 through apparatus 10 when the desired amount of water has been dispensed, as will be discussed presently.

Apparatus 10 further includes a metering sensor 54, preferably a flowmeter, for measuring the flow of water 42 through apparatus 10. In other applications, metering sensor 54 may, for example, weigh the fluid as it passes or use optical sensing to determine the amount of fluid dispensed. Regardless, sensor 54 generates output signal 20 indicative of the amount of water flowing through apparatus 10. In one embodiment of inventive apparatus 10, apparatus 10 may further include a temperature sensor 56, which measures the temperature of water 42 as it flows through apparatus 10. Temperature sensor 56 may be embodied integrally with measuring sensor 54, but is shown here as being separate for ease of illustration. It goes without saying that apparatus 10 should be waterproof, to prevent damage to internal electrical components thereof while in operation.

Apparatus 10 also includes as input interface 22, a user input component 58, for inputting the desired amount of fluid to be dispensed, and, if appropriate, the desired temperature of the fluid to be dispensed. User input component 58 may be of any desired type, suitable for a particular application, such as, but not limited to, a dial, a keypad, a touch screen input device, a cell phone, a computer, or a tablet. User input component 58 may be permanently mounted to the installation (if not part of a mobile device), for example by mounting on spout 36, by mounting on the exterior of apparatus 10 (FIG. 2), or even fixed to the sink, as suggested by the alternative placement 58′ in FIG. 2. If user input component 58 is mounted to the exterior of apparatus 10, it may be directly connected to the other components of apparatus 10 by suitable wiring. If remote from the other components of apparatus 10, it may be connected wirelessly, as through an RF connection or a Bluetooth connection. If user input component 58′ is part of a pre-existing computing device, such as a cell phone, computer or tablet, the computing device would have to have an app or other software suitable for accepting a user input indicative of the desired amount (and temperature, if desired) of fluid to be dispensed, and generating a signal corresponding to that user input. This is a fairly routine process, and would be a trivial matter for one of ordinary skill in the art to program. The basic steps of the program would be to provide an interface to accept a user input, a prompt to the user to input the desired amount (and temperature, if desired) of fluid to be dispensed, and then generate a signal corresponding to the input to the other components of apparatus 10. It may also be possible for input component 58 or 58′ to receive feedback from metering sensor 54 and provide a visual or auditory output to the user, advising of the status of the dispensing process, such as, for example, the current temperature of the fluid (if changing), and how far along the dispensing process has advanced.

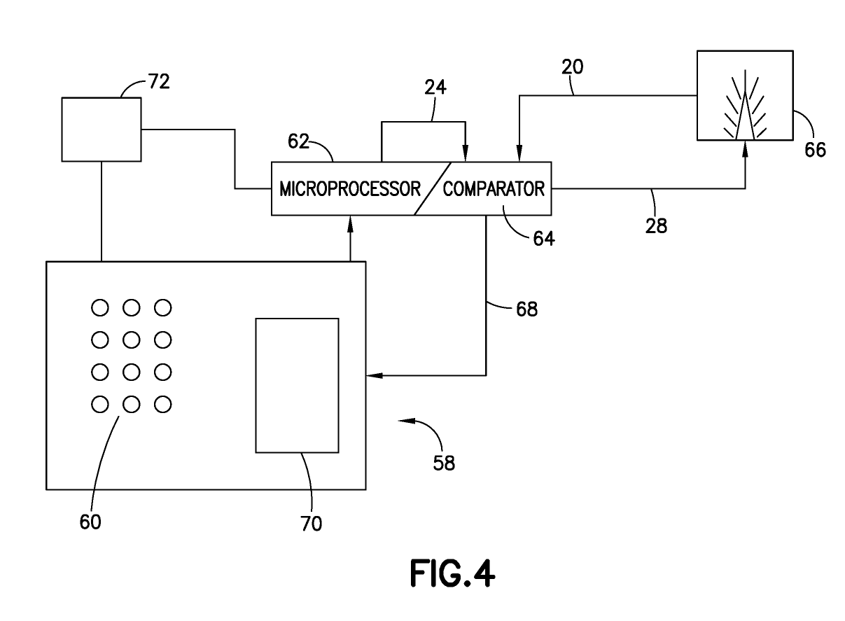

The elements of input component 58 (or 58′) are illustrated schematically in FIG. 4. Input component 58 includes an input area 60, such as a dial, keypad (illustrated) or touch screen input, a processing device 62 such as a microprocessor suitably programmed, to convert the input from input area 60 to signal 24 and send signal 24 out to a comparator 64. Comparator 64 may be a part of processing device 62, or a separate component, depending upon the application. Unless comparator 62 is wired to the other components, comparator 62 is coupled to a wireless interface 66, such as an RF transmitter/receiver or a Bluetooth device. Wireless interface 66 receives signal 20 from meter 18 (FIG. 1) and relays it to comparator 62, so that comparator 62 may compare the desired amount (and temperature, if desired) of fluid to be dispensed as indicated by signal 24, with the actual amount of fluid exiting output 50 of apparatus 10 (FIG. 3) as indicated by signal 20, and relays shut-off signal 28 from comparator 64 when the desired amount of fluid has been dispensed.

Processing device 62 may also send a signal 68 to an output device, such as an alarm, a buzzer, other auditory alert, or a visual alert such as a display screen 70 (illustrated), Display 70 may output the current status of the dispensing process and/or alert the user when that process is complete.

In a preferred embodiment of the invention, apparatus 10 would provide a further input to shut-off 30, for initiating the dispensing process, and initiating the commencement of measuring by metering device 18, allowing the user to position a suitable receptacle, such as measuring cup 44, in the path of the flow of fluid 14, as illustrated in FIG. 2. That would ensure that the proper amount of fluid is dispensed. This would also provide the opportunity to allow the fluid to reach a desired temperature, if that is desired, and for metered dispensing to commence only when that temperature of the fluid has been achieved. Furthermore, by having an affirmative “on” command for metered dispensing, it is possible to have an unmetered dispensing of the fluid as desired, such as, for example, for use in the sink to wash dishes.

To power the various components of apparatus 10, apparatus 10 may have a power source, such as a battery 72 (shown in FIG. 3). In this embodiment of the invention, apparatus 10 may include a flywheel 74 which generates a current 76 when rotated by the passage of water 42 through apparatus 10, to power or re-charge battery 72. Preferably, flywheel 74 may be part of flowmeter 54, although it is shown separately for illustrative purposes.

Where apparatus 10 is retro-fitted to an existing faucet, it is preferred if apparatus 10 further includes an attachment mechanism 78, to attach apparatus 10 to outlet 38 of faucet 32. Where outlet 38 includes a threaded portion 80, attachment mechanism 78 may have a further threaded portion 82 which is complementary to threaded portion 80 of outlet 38 of faucet 32. Alternatively, attachment mechanism 78 may snap on to outlet 38 of faucet 32. As used herein, the term “snap on” is intended to include situations where outlet 38 of faucet 32 has a rim 84 over which a deformable flange 86 may “snap” into place, as well as situations where no such rim 84 exists, and so the attachment is performed solely by friction-fitting a deformable gasket 88 on the interior of apparatus 10 over outlet 38 of faucet 32. If faucet 32 has other configurations, other, not illustrated, methods of attachment could be used, such as, for example, a tongue-and-groove fitting, or even adhesive, although it is preferred for maintenance and repair purposes if apparatus 10 is removable from faucet 32.

Another option for apparatus 10 would be to have processor 62 store pre-programmed recipes or combinations of desired amounts of fluids in the comparator to use in preparing meals.

It will be appreciated that, while the preferred embodiment is described in relation to a kitchen, the inventive apparatus may be used in any environment in which fluids are to be dispensed, such as, for example, in a laboratory.

In the preceding Detailed Description, reference was made to the accompanying drawings, which form a part of this disclosure, and in which are shown illustrative specific embodiments of the invention. In this regard, directional terminology, such as “top”, “bottom”, “left”, “right”, “front”, “back”, etc., is used with reference to the orientation of the Figure(s) with which such terms are used. Because components of embodiments can be positioned in a number of different orientations, the directional terminology is used for purposes of ease of understanding and illustration only and is not to be considered limiting.

Additionally, while there have been shown and described and pointed out fundamental novel features of the invention as applied to a preferred embodiment thereof, it will be understood that various omissions and substitutions and changes in the form and details of the apparatuses illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A fluid metering and dispensing apparatus, for use with a fluid source, the fluid source having a fluid outlet, the apparatus comprising:
an interface for receiving an input from a user establishing an amount of fluid to be dispensed, and for outputting a signal in response to said user input, said signal being indicative of said established amount of fluid to be dispensed;
a meter for measuring the amount of fluid exiting the fluid outlet, said meter generating an output signal indicative of the measured amount of fluid;
a comparator for receiving said signals from said interface and said meter, and for comparing the measured amount of fluid exiting the fluid outlet with the amount of fluid established by said user input to said interface, said comparator generating an output signal; and
a shut-off for receiving said output signal of said comparator and for shutting off a flow of fluid through the fluid outlet once the measured amount of fluid exiting the fluid outlet reaches the established amount of fluid to be dispensed.

2. The fluid metering and dispensing apparatus of claim 1, wherein said interface is selected from the group consisting of: a keypad, a touch screen input device, a cell phone, a computer, a tablet and a virtual assistant.

3. The fluid metering and dispensing apparatus of claim 1, wherein the fluid source is a faucet.

4. The fluid metering and dispensing apparatus of claim 1, wherein said signal indicative of said established amount of fluid to be dispensed is transmitted from said interface to said comparator over a wired connection.

5. The fluid metering and dispensing apparatus of claim 1, wherein said signal indicative of said established amount of fluid to be dispensed is transmitted from said interface to said comparator over a wireless connection.

6. The fluid metering and dispensing apparatus of claim 5, wherein said wireless connection is a Bluetooth connection.

7. The fluid metering and dispensing apparatus of claim 1, wherein said meter is a flowmeter.

8. The fluid metering and dispensing apparatus of claim 7, wherein said flowmeter includes a flywheel for generating electricity by the passage of the fluid through the fluid metering and dispensing apparatus.

9. The fluid metering and dispensing apparatus of claim 8, further comprising:
a battery for powering at least one of said interface, said meter, said comparator and said shut-off;
wherein said flywheel is coupled to recharge said battery by the passage of the fluid through the fluid metering and dispensing apparatus.

10. The fluid metering and dispensing apparatus of claim 1, wherein the fluid metering and dispensing apparatus is integrated into a water filtration system.

11. The fluid metering and dispensing apparatus of claim 1, wherein said shut-off is a solenoid-actuated valve.

12. The fluid metering and dispensing apparatus of claim 1, wherein the fluid is water.

13. The fluid metering and dispensing apparatus of claim 1, wherein the fluid metering and dispensing apparatus is integrated into a faucet system.

14. The fluid metering and dispensing apparatus of claim 1, further comprising:
means for attaching the fluid metering and dispensing apparatus to a pre-existing faucet.

15. The fluid metering and dispensing apparatus of claim 14, wherein the faucet includes a threaded output end; and
said means for attaching includes a threaded attachment complementary to the threads of the threaded output end of the faucet.

16. The fluid metering and dispensing apparatus of claim 14, wherein said means for attaching includes a snap-on fitting to secure the fluid metering and dispensing apparatus to an output end of the faucet.

17. A water metering and dispensing apparatus, for use with a water source, the water source having an outlet, namely a faucet, the apparatus comprising:
an interface for receiving an input from a user establishing an amount of water to be dispensed, and for outputting a signal in response to said user input, said signal being indicative of said established amount of water to be dispensed;
a flowmeter for measuring the amount of water exiting the faucet, said flowmeter generating an output signal indicative of the measured amount of water;
a general purpose computing device, including a comparator for receiving said signals from said interface and from said flowmeter, and for comparing the measured amount of water exiting the faucet with the amount of water established by said user input to said interface, said comparator generating an output signal; and
a solenoid shut-off for receiving said output signal from said comparator and for shutting off a flow of water through the faucet once the measured amount of water exiting the faucet reaches the established amount of water to be dispensed.

18. The fluid metering and dispensing apparatus of claim 17, wherein said flowmeter includes a flywheel for generating electricity by the passage of the fluid through the fluid metering and dispensing apparatus.

19. The fluid metering and dispensing apparatus of claim 18, further comprising:
a battery for powering at least one of said interface, said flowmeter, said general purpose computing device and said solenoid shut-off;
wherein said flywheel is coupled to recharge said battery by the passage of the fluid through the fluid metering and dispensing apparatus.

20. The fluid metering and dispensing apparatus of claim 17, further comprising:
means for attaching the water metering and dispensing apparatus to the faucet.
